(19) United States
(12) Patent Application Publication
(10) Pub. No.: US 2023/0206287 A1
(43) Pub. Date: Jun. 29, 2023

(54) MACHINE LEARNING PRODUCT DEVELOPMENT LIFE CYCLE MODEL

(71) Applicant: Microsoft Technology Licensing, LLC, Redmond, WA (US)

(72) Inventor: Prabhakaran SETHURAMAN, Redmond, WA (US)

(21) Appl. No.: 17/560,765

(22) Filed: Dec. 23, 2021

(51) Int. Cl. G06Q 30/02; G06N 7/02; G06N 20/00

(52) U.S. Cl. CPC G06Q 30/0282; G06N 7/02; G06N 20/00

(57) ABSTRACT

A machine learning product development life cycle model improves the utility of customer or support products by prioritizing improvements in such products based on classification of interpretations of customer and/or support agent input. A product satisfaction monitor receives user satisfaction (SAT) reports with SAT scores. Feedback is requested for low SAT scores. A feature extractor/preprocessor prepares model descriptions and sentiment from SAT reports based on case descriptions for mid- to high-range SAT scores and from feedback for low-range SAT scores. An intent classifier model classifies product issues based on description and sentiment. A remedy prioritizer model associates a priority of product improvement with each SAT report (or related group of reports) based on the classified product issue, sentiment, SAT score and/or number of SAT reports (e.g., for a single service request). A product improvement scheduler schedules each SAT report for remediation in an improved product based on each associated priority.

In an effort to improve customer satisfaction, customer support agents provide support for customers of complex products, such as computer-implemented products (e.g., Microsoft Azure® cloud platform with over 200 products and cloud services and millions of customers). Agents may use customer support tools to assist with resolution of issues that customers have with products. Customers and/or agents may generate voluminous information about their positive and negative experiences with customer and/or service agent products that may be extremely time-consuming for engineering teams to review, interpret and determine priorities for product improvements. Some products may be prematurely abandoned due to inefficiencies in contending with significant product dissatisfaction and an inability to swiftly generate the most important remedies for product users.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems and computer program products are provided for machine learning product and product support development. A machine learning (ML) product development life cycle (PDLC) model may improve the utility of customer and/or support agent products (and thus improve customer and/or customer support agent satisfaction) by prioritizing improvements in such products based on classification of interpretations of voluminous customer and/or support agent input about one or more products. A product satisfaction monitor may receive a plurality of satisfaction (SAT) reports from users about a product. A SAT report (e.g., for a service request (SR)) may include an SAT score. A low score trigger may request feedback for low SAT scores to develop additional information. A feature extractor and preprocessor may prepare model descriptions and sentiment expressed in SAT reports from one or more sources (e.g., from case descriptions for mid- to high-range SAT scores and from feedback for low-range SAT scores). An intent classifier configured with one or more intent classifier models may (e.g., separately based on SAT score range) classify product issues based on the description and sentiment expressed for each of the plurality of SAT reports. A remedy prioritizer configured with a fuzzy logic remedy prioritizer model may associate a priority of product improvement with each of the plurality of SAT reports based on the classified product issue, sentiment, SAT score and/or number of SAT reports (e.g., for a single SR). A product improvement scheduler may schedule each of the plurality of SAT reports for remediation (e.g., by one or more engineering teams) based on each associated priority of product improvement for ordered implementation in an improved product. A satisfaction improvement tracker may track user satisfaction with different versions of products.

Further features and advantages of the invention, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of an example computing environment for machine learning product and product support development, according to an example embodiment.

FIG. 2 shows an example method of implementing a PDLC model for product development, according to an example embodiment.

FIG. 3 shows a block diagram of an example implementation of a product satisfaction monitor and product development scheduler, according to an example embodiment.

FIG. 4 shows a block diagram of an example of a PDLC model, according to an example embodiment.

FIG. 5 shows a logic table with examples of fuzzy logic rules for a remedy prioritization model, according to an example embodiment.

FIG. 6 shows a flowchart of an example method for prioritizing and scheduling completion of product remedies based on an intent classifier model and a remedy prioritizer model, according to an example embodiment.

FIG. 7 shows a block diagram of an example computing device that may be used to implement example embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the present invention. The scope of the present invention is not limited to the disclosed embodiments. The disclosed embodiments merely exemplify the present invention, and modified versions of the disclosed embodiments are also encompassed by the present invention. Embodiments of the present invention are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an example embodiment of the disclosure, are understood to mean that the condition or characteristic is defined to within tolerances that are acceptable for operation of the embodiment for an application for which it is intended.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Implementations

Methods, systems and computer program products are provided for machine learning product and product support development. A machine learning (ML) product development life cycle (PDLC) model may improve the utility of customer and/or support agent products (thus improving customer and/or customer support agent satisfaction) by prioritizing improvements in such products based on classification of interpretations of voluminous customer and/or support agent input about one or more products. A product satisfaction monitor may receive a plurality of satisfaction (SAT) reports from users about a product. An SAT report (e.g., for a service request (SR)) may include an SAT score. A low score trigger may request feedback for low SAT scores to develop additional information. A feature extractor and preprocessor may prepare model descriptions and sentiment expressed in SAT reports from one or more sources (e.g., from case descriptions for mid- to high-range SAT scores and from feedback for low-range SAT scores). An intent classifier configured with one or more intent classifier models may (e.g., separately based on SAT score range) classify product issues based on the description and sentiment expressed for each of the plurality of SAT reports. A remedy prioritizer configured with a fuzzy logic remedy prioritizer model may associate a priority of product improvement with each of the plurality of SAT reports based on the classified product issue, sentiment, SAT score and/or number of SAT reports (e.g., for a single SR). A product improvement scheduler may schedule each of the plurality of SAT reports for remediation (e.g., by one or more engineering teams) based on each associated priority of product improvement for ordered implementation in an improved product. A satisfaction improvement tracker may track user satisfaction with different versions of products.

Customer satisfaction is a common pursuit for product and/or service oriented organizations. Customer satisfaction is a measure of quality for a product team. Agent satisfaction is a measure of quality for a customer service team (e.g., a desktop computer support group). Customer issues may be raised at service desk level, for example, using a case management tool. Customer service agents at a service desk help customers resolve issues with products. Customer satisfaction and/or agent satisfaction may be tracked and trended as metric(s). Agent satisfaction may intimate customer satisfaction, for example, if/when agents are experienced with support tools and the agents are satisfied with their role providing customer service. Agent tooling satisfaction may be prioritized for improvement, for example, to (e.g., inherently) improve customer satisfaction. Improving agent tooling experience may improve agent productivity, reduce stress, improve focus on improvement and/or innovation to enhance customer experience, retain knowhow and expertise, reduce agent turnover, improve profitability (e.g., by avoiding costs to screen, recruit, interview, and train replacements).

A PDLC model may extend product life by improving customer satisfaction and/or customer support agent satisfaction, which may lead to lead to customer adoption or retention of products/platforms. Customer satisfaction with one or more products may be linked to the satisfaction of customer support agents with one or more customer support tools. Customer satisfaction with one or more products may be improved by improving the satisfaction of customer support agents with one or more customer support tools. Customer support may be improved by improving customer support tools based on input provided by customer support agents. Improving customer support tools implemented as software that executes on one or more computing devices can also improve the functioning of the computing device(s) themselves, as problems with customer support tools can impact the performance of the computing device(s) upon which they execute (e.g., by slowing down or crashing such devices or unnecessarily consuming resources of the devices such as processor cycles and memory).

Input from customers and/or support agents may be immense for a widely used complex product, such as a software platform product. A PDLC model (e.g., with supervised or unsupervised learning) may quickly prioritize issues for work items across many inputs from many agents to improve customer and support agent satisfaction with products and/or customer support tools.

A product development scheduler may implement a PDLC model. A PDLC model may include, for example, an input feature extractor, an input feature preprocessor, an intent classifier (e.g., to classify product issues) and a remedy prioritizer.

A product satisfaction monitor may provide input data preparation. A product satisfaction monitor may implement a blended product satisfaction information collection model. e.g., including a cause and effect (e.g., “Fishbone”) analysis and a closed feedback loop (CFL) analysis, collectively FCFL. The cause and effect of dissatisfaction (DSAT) of a customer and/or a customer support agent with their respective products may be identified. A closed feedback loop may identify repair items to improve customer and/or customer support agent products.

A PDLC model may employ intent analysis to gauge a users' intent (e.g., needs, opinions, requests, preferences). Intent analysis may determine product gaps (e.g., in terms of product performance, functionality and/or quality). Intent analysis may be implemented, for example, by (e.g., supervised or unsupervised) machine learning (ML) and natural language processing (NLP).

A PDLC model may employ remedy prioritization to prioritize remedies for classified product issues. A remedy prioritization model may (e.g., automatically) prioritize product issues for remediation based on product issue classifications. An software development life cycle (SDLC) model may be implemented with a fuzzy logic rule-based forecasting model. In some examples, a forecasting model may be based on (e.g., specific to) customer satisfaction with customer products. In some examples, a forecasting model may be based on (e.g., specific to) customer support agent satisfaction and the effect of customer support agent satisfaction on customer satisfaction (CSAT).

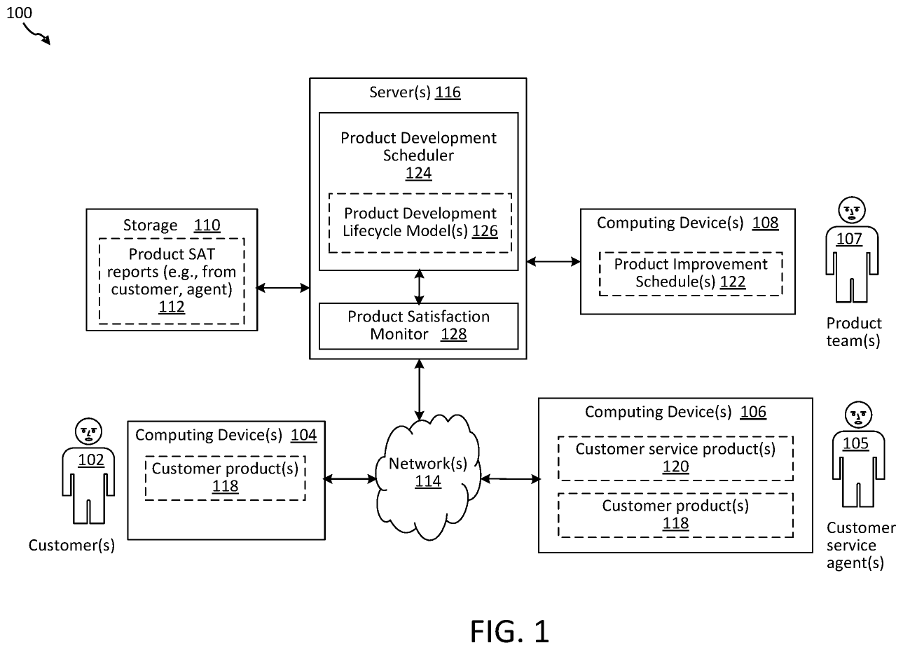

FIG. 1 shows a block diagram of an example computing environment for machine learning product and product support development, according to an example embodiment. Example computing environment 100 may include, for example, computing device(s) 104, which may be used by product customer(s) 102, computing device(s) 106, which may be used by customer service agent(s)) 105, computing device(s) 108, which may be used by product team(s)) 107, network(s) 114, server(s) 116, and storage 110. Example computing environment 100 presents one of many possible examples of computing environments. Example computing environment 100 may comprise any number of computing devices and/or servers, such as example components illustrated in FIG. 1 and other additional or alternative devices not expressly illustrated.

Network(s) 114 may include, for example, one or more of any of a local area network (LAN), a wide area network (WAN), a personal area network (PAN), a combination of communication networks, such as the Internet, and/or a virtual network. In example implementations, computing device(s) 104 and server(s) 116 may be communicatively coupled via network(s) 114. In an implementation, any one or more of server(s) 116 and computing device(s) 104 may communicate via one or more application programming interfaces (APIs), and/or according to other interfaces and/or techniques. Server(s) 116 and/or computing device(s) 104 may include one or more network interfaces that enable communications between devices. Examples of such a network interface, wired or wireless, may include an IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, a near field communication (NFC) interface, etc. Further examples of network interfaces are described elsewhere herein.

Computing device(s) 104 may comprise computing devices utilized by one or more customers (e.g., individual users, family users, enterprise users, governmental users, administrators, etc.) generally referenced as customer(s) 102. Computing device(s) 104 may comprise one or more applications, operating systems, virtual machines (VMs), storage devices, etc. that may be executed, hosted, and/or stored therein or via one or more other computing devices via network(s) 114. In an example, computing device(s) 104 may access one or more server devices, such as server(s) 116, to request service (e.g., service request (SR)) and/or to provide information, such as product satisfaction (SAT) reports. Computing device(s) 104 may represent any number of computing devices and any number and type of groups (e.g., various users among multiple cloud service tenants). Customer(s) 102 may represent any number of persons authorized to access one or more computing resources. Computing device(s) 104 may each be may be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device, or other type of mobile device, or a stationary computing device such as a desktop computer or PC (personal computer), or a server. Computing device(s) 104 are not limited to physical machines, but may include other types of machines or nodes, such as a virtual machine.

In some examples, customer product(s) 118 may be one or more computer products (e.g., hardware, firmware or software) in computing device(s) 104 used by customer(s) 102. Customer(s) 102 may use customer product(s) 118 in computing device(s) 104. Customer(s) 102 may provide product satisfaction (SAT) reports 112 to product satisfaction monitor 128 (e.g., via an online submission form) and/or through communication with customer service agent(s) 105 (e.g., by providing an SR).

Computing device(s) 106 may comprise computing devices utilized by one or more customer service agent(s) 105. Computing device(s) 106 may comprise one or more applications, operating systems, virtual machines (VMs), storage devices, etc. that may be executed, hosted, and/or stored therein or via one or more other computing devices via network(s) 114. In an example, computing device(s) 106 may access one or more server devices, such as server(s) 116, to provide and/or access information, such as SRs, product SAT reports, etc. Computing device(s) 106 may represent any number of computing devices and any number and type of groups (e.g., various users among multiple cloud service tenants). Customer service agent(s) 105 may represent any number of persons authorized to access one or more computing resources. Computing device(s) 106 may each be may be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device, or other type of mobile device, or a stationary computing device such as a desktop computer or PC (personal computer), or a server. Computing device(s) 106 are not limited to physical machines, but may include other types of machines or nodes, such as a virtual machine.

Customer service agent(s) 105 may field service requests (SRs) from customer(s) 102 regarding customer product(s) 118 or related matters, such as billing. Customer service agent(s) 105 may reference customer product(s) 118 while handling SRs by customer(s) 102. In some examples, customer product(s) 118 may be one or more computer products (e.g., hardware, firmware or software) in computing device(s) 106 available to customer service agent(s) 105. Customer service agent(s) 105 may receive product satisfaction (SAT) reports from customer(s) 102 for customer product(s) 118. Customer service agent(s) 105 may create SRs for customer(s) 102. Customer service agent(s) 105 may create SR (e.g., case) tickets for SRs. An SR (e.g., as may be represented by a ticket) may be associated with one or more customer SR reports (e.g., about experience with customer product(s) 118) and/or agent SR reports (e.g., about experience with customer product(s) 118 and/or about experience with customer service product(s) 120). Customer service agent(s) 105 may use customer service products 120 to provide service to customer(s) 102. Customer service agent(s) 105 may provide product SAT reports regarding their experience with customer product 118 and/or customer service products 120 (e.g., while attempting to resolve issues for customer(s) 102). Customer service agent(s) 105 may interact with product satisfaction monitor 128 to provide and/or to retrieve information, such as customer SAT reports or agent SAT reports. For example, customer service agent(s) 105 may provide agent SAT reports to product satisfaction monitor 128 (e.g., via an online submission form). Customer service agent(s) 105 may provide feedback requested by product satisfaction monitor 128 in response to providing a low SAT score in a product SAT report 112.

Computing device(s) 108 may comprise computing devices utilized by one or more product engineering team(s) 107. Computing device(s) 108 may comprise one or more applications, operating systems, virtual machines (VMs), storage devices, etc. that may be executed, hosted, and/or stored therein or via one or more other computing devices (e.g., server(s) 116). In an example, computing device(s) 108 may access one or more server devices, such as server(s) 116, to provide and/or access information, such as product SAT reports 112, product improvement schedule 122, etc. Computing device(s) 108 may represent any number of computing devices and any number and type of groups (e.g., various users among multiple cloud service tenants). Product team(s) 107 may represent any number of persons authorized to access one or more computing resources. Computing device(s) 108 may each be may be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device, or other type of mobile device, or a stationary computing device such as a desktop computer or PC (personal computer), or a server. Computing device(s) 108 are not limited to physical machines, but may include other types of machines or nodes, such as a virtual machine.

Product team(s) 107 may represent one or more product teams (e.g., customer product teams and/or customer service product (service tool) teams). Product team(s) 107 may improve products (e.g., to create improved products) based on product improvement schedule(s) 122 provided by product development scheduler 124. Product improvement schedule(s) 122 may include schedules for one or more products (e.g., customer products and/or customer service products, which may be referred to as service tools). Product team(s) 107 may develop improvements to customer product(s) 118 and/or customer service product(s) 120 by creating solutions to issues reported in product SAT reports 112, which may be addressed by product team(s) 107 in a prioritized order by product improvement schedule(s) 122.

Server(s) 116 may comprise one or more computing devices, servers, services, local processes, remote machines, web services, etc. to monitor product satisfaction, store product SAT reports 112, interpret product SAT reports 112, and prioritize product development based on classification of product issues in SR report materials, sentiment expressed in SR report materials, the number of related SAT reports provided by a customer and/or a service agent. SAT scores, etc. In an example, server(s) 116 may comprise a server located on an organization's premises and/or coupled to an organization's local network, a remotely located server, a cloud-based server (e.g., one or more servers in a distributed manner), or any other device or service that may host, manage, and/or provide ML models, ML model selection, ML model training, etc. Server(s) 116 may be implemented as a plurality of programs executed by one or more computing devices. Server programs and content may be distinguished by logic or functionality (e.g., as shown by example in FIG. 1).

Server(s) 116 may include product satisfaction monitor 128. Product satisfaction monitor 128 may (e.g., passively and/or actively) receive and/or request information pertaining to satisfaction of customers 102 and/or agents 105 with customer products 118 and/or satisfaction of agents 105 with customer service products 120. For example, product satisfaction monitor 128 may provide an online (e.g., Web) form for customers 102 and/or agents 105 to fill out. Product satisfaction monitor 128 may receive, organize and store information received from customers 102 and/or agents 105, for example, as product SAT reports 112 in storage 110. SAT reports 112 may include SAT scores. Product satisfaction monitor 128 may provide (e.g., online, by email) product surveys for customers 102 and/or agents 105 to fill out to describe satisfaction/dissatisfaction and/or any issues with one or more products. Customer service product(s) 120 may be linked to product satisfaction monitor 128, for example, as an organized repository (e.g., structured query language (SQL) database) of product satisfaction information. Product satisfaction monitor 128 may request feedback from customers 102 and/or agents 105, for example, based on low SAT scores. Feedback provided by customer(s) 102 and/or agent(s) 105 may provide additional (e.g., extended or more detailed) information than information provided in an underlying product SAT report 112. Multiple product SAT reports 112, such as a case report and feedback) may be associated (e.g., combined or merged) for reference (e.g., by product development scheduler 124).

Server(s) 116 may include product development scheduler 124. Product development scheduler 124 may generate product improvement schedule(s) 122 for product team(s) 107. Product development scheduler 124 may include product development lifecycle (PDLC) model(s) 126. A PDLC model may be a software development lifecycle (SDLC) model. PDLC model(s) 126 may improve customer and support agent satisfaction by prioritizing improvements in customer product(s) 118 and/or customer service product(s) 120 based on classification of interpretations of customer and/or support agent input, such as in product SAT reports 112. PDLC model(s) 126 may include, for example, a feature extractor/preprocessor, an intent classifier, and a remedy prioritizer. A feature extractor/preprocessor may prepare descriptions and sentiment from product SAT reports 112 based on SR (e.g., case) descriptions for mid- to high-range SAT scores and from requested feedback for low-range SAT scores. An intent classifier model may classify product issues based on the description and sentiment. A remedy prioritizer model may associate a priority of product improvement with each product SAT report (or related group of reports) 112 based on the classified product issue, sentiment, SAT score and/or number of SAT reports 112 (e.g., for a single SR/case). Product development scheduler 124 may generate product improvement schedule(s) 122, indicating to product team(s) 107 a priority for remediation (e.g., in an improved product) for each product SAT report (or related group of reports) 112.

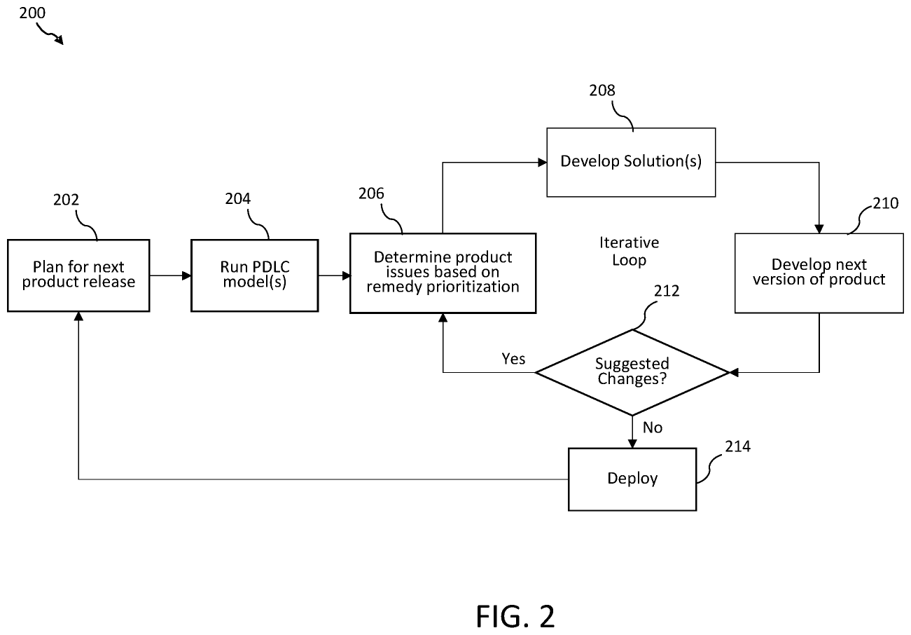

FIG. 2 shows an example method of implementing a PDLC model for product development, according to an example embodiment. A PDLC model may be implemented in any industry or vertical to improve customer and/or customer support agent experience with one or more product(s). A blended iterative model framework may be implemented, for example, in a commerce support platform. Example method 200 presents one of many possible example methods of implementation of PDLC model(s) 126. Embodiments disclosed herein and other embodiments may operate in accordance with example method 200. Example method 200 comprises steps 202-214. However, other embodiments may operate according to other methods. Other structural and operational (e.g., method) embodiments will be apparent to persons skilled in the relevant art(s) based on the foregoing discussion of embodiments. No order of steps is required unless expressly indicated or inherently required. There is no requirement that a method embodiment implement all of the steps illustrated in FIG. 2. Embodiments may implement fewer, more or different steps.

As shown in FIG. 2, in step 202, planning may occur for the next release of a product. Planning may occur, for example, after deployment of an improved product 214.

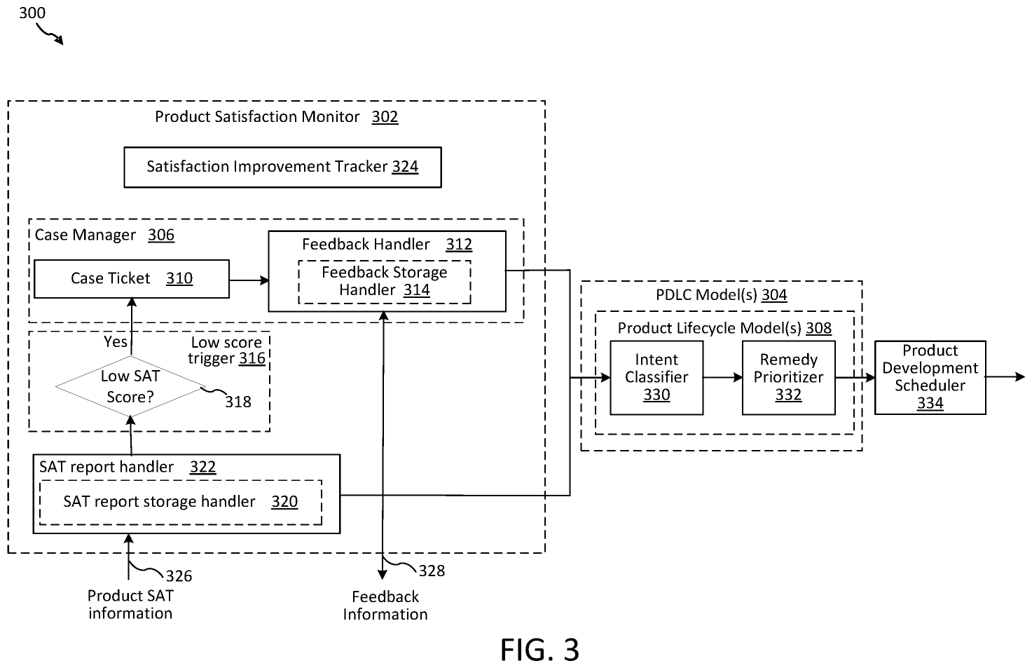

In step 204, one or more PDLC models may be executed, for example, in the environment shown by example in FIG. 1. As discussed with respect to the example shown in FIG. 3, one or more PDLC models may be executed in conjunction with implementation of a blended model, such as a mixture of cause and effect (e.g., fishbone) and closed feedback loop (FCFL), for example, to develop product SAT information for feature extraction and preprocessing. PDLC model(s) may generate one or more remedy prioritization schedules (e.g., product improvement schedule(s) 122 shown in FIG. 1).

In step 206, product issues may be determined based on remedy prioritization determined in step 204. For example, one or more product team(s) (e.g., product team(s) 107) may address product SAT reports in order of priority to determine technical issues to be solved.

In step 208, solutions may be developed for technical issues determined in step 206. For example, one or more product team(s) (e.g., product team(s) 107) may address technical issues determined in step 206 in order of priority to determine technical solutions.

In step 210, the next version of the product (e.g., an improved product) may be developed by implementing the technical solutions in order of priority.

In step 212, a determination may be made whether to implement changes in product issues and/or product solutions. For example, a determination may be made whether to implement changes in product issues and/or product solutions after product team(s), customer service agent(s) and/or customers review and provide comments about the next version of the product (e.g., whether the prioritized product solutions adequately resolve the prioritized product issues). In some examples, an agent may be aware of prioritized remedies scheduled for product edits in the next (e.g., improved) version of a product. An agent may suggest changes to revise and/or add product (e.g., support tool) feedback. A model may run periodically, for example, to update intent classifications and remedy prioritizations based on new and/or updated feedback.

In step 214, the next version of the product (e.g., improved product) may be deployed if there are no suggested changes or if none of the suggested changes will be pursued in the next version of the product (e.g., because the improved product satisfies the prioritized product issues). For example, an improved customer service tool may be deployed for use by customer service agents or an improved customer product may be deployed for use by customers.

If, at step 214, there are suggested changes in product issues and/or product solutions, the method may return (e.g., in an iterative loop) to step 206, for example, to revise product issues and/or revise product solutions in step 208. An iterative determination of product issues and solutions may improve satisfaction with each product release. Iterations (e.g., involving customers and/or customer agents) may address gaps in product solutions in the same phase to provide phase containment of errors, which may reduce or eliminate supportability bugs/errors in improved products.

FIG. 3 shows a block diagram of an example implementation of a product satisfaction monitor and product development scheduler, according to an example embodiment. Example 300 shows examples of product satisfaction monitor 128 and product development scheduler 124 shown in FIG. 1.

Product satisfaction monitor 302 may include SAT report handler 322. SAT report handler 322 may request, receive, store and perform other actions for product SAT information 326. SAT report storage handler 320 may store product SAT information 326 (e.g., for subsequent feature extraction), for example, in a structured query language (SQL) database. Product SAT information 326 may include, for example, one or more of the following: case number (e.g., support request (SR) Number), case title, case description, case closed date and time, agent alias, customer ID, total agent and/or customer score, total number of surveys provided by an agent, billing platform, tool used, total customer satisfaction score, and/or agent and/or customer remarks (e.g., if any), an SAT score, etc. Product satisfaction monitor 302 may receive product SAT information 326 by one or more types of communication or data acquisition (e.g., web form, email, SR case forwarding). Product satisfaction monitor 302 may analyze information (e.g., SAT scores) to determine whether to acquire additional information.

Product satisfaction monitor 302 may implement a blended (e.g., FCFL) framework for data collection and analysis in preparation of feature extraction. Cause and effect determination of customer and/or agent DSAT in product SAT information 326 and feedback information 328 may be implemented as a reactive approach while identification of improvements (e.g., repairs) may be implemented as a proactive approach.

Product satisfaction monitor 302 may utilize the components of a blended information collection and analysis framework based on customer scores. For example, product satisfaction monitor 302 may use closed loop feedback to follow-up with customers and % or agents who have given a low score. Product satisfaction monitor 302 may include low score trigger (e.g., filter) 316. Low score trigger 316 may determine 318 whether an SAT score in product SAT information 326 is low-range (e.g., 1 or 2 out of 5). Low score trigger 316 may trigger case manager 306 involvement if an SAT score is determined to be low-range.

In an example, an agent may provide product SAT information for a customer service tool. Product SAT information 326 provided by the agent may include, for example, one or more of the following: customer SR case title, customer SR case description, case closed date and time, agent alias, total agent score, total number of surveys filled by an agent, billing platform, tool used, total customer satisfaction score, agent remarks (e.g., if any). Low score trigger 316 may (e.g., in real time) filter product SAT information 326 with low scores (e.g., score=1 or 2). Low score trigger 316 may (e.g., for each survey) filter out agent information (e.g., agent aliases) associated with each (e.g., low score) survey.

Case manager 306 may, upon activation based on a detection of a low score, create a case ticket 310 and a low score notification (e.g., email), which may include a feedback request generated by feedback handler 312. Feedback handler 312 may trigger an automated low score notification (e.g., email) to each customer and/or agent who gave a low score. An SAT score may be provided by a customer and/or an agent in SAT surveys, which may be customer and/or agent initiated, provided at the time of ticket closure, etc. Survey responses and/or other comments by customers and/or agents may or may not include detailed statements that may be useful for product issue interpretation (e.g., intent analysis) and/or remedy prioritization. Following up by requesting additional information may improve input data (e.g., pain points) for intent classification and remedy prioritization. In some examples, customers and/or agents may be contacted via one or more communication platforms (e.g., email, phone call, online video chat/call) to improve documentation of pain-points, which may help identify potential product issues. A low score notification from feedback handler 312 may request that a customer and/or agent provide details (e.g., reasoning) for low scores and/or to suggest improvement areas. A low score notification may include survey response details, such as case identifier (ID), title, description, agent score, tool used, agent's verbatim, service desk uniform resource locater (URL) and/or ticket closure date.

Feedback handler 312 may receive feedback information 328. Feedback storage handler 314 may store feedback information 328. Feedback storage handler 314 may associate feedback information 328 with one or more related SAT report(s) (e.g., SAT reports that activated case manager 306 based on low SAT score(s)). In some examples, feedback requests and feedback information 328 may pass through product SAT report handler 322. Information may be received from agents and/or customers (e.g., in response to a low score notification), for example, by email, text messaging, phone call, video call, chat, etc. Feedback information 328 received may indicate one or more pain-points with one or more products. Information (e.g., feedback) received from customers and/or agents may be stored, for example, as case reviews.

Feedback information 328 acquired by case manager 306 may be used to identify areas to improve and create repair items for one or more products. Repair items may seek to improve one or more of the following, for example, product documentation, process, tool updates or features. Implementation of repair items may improve customer and/or agent satisfaction. Feedback storage handler 314 may store (e.g., in SQL) and/or access customer and/or agent feedback, pain-points and repair item details, for example, for each case ticket generated by case manager 306.

Customer and/or customer service agent satisfaction with one or more products may be improved by accurately understanding the intent of customers and/or agents expressed in various forms of communication (e.g., survey, feedback). Intent may indicate product user needs and suggestions, e.g., especially for customers and/or agents who expressed low scores for customer products and/or agent tooling products. Survey responses may be submitted by customers and/or by support agents (e.g., at the time of customer tickets or case closure). There may be large volumes of cases submitted every day for a product with many users. It may be difficult for agents to provide verbatim descriptions of customer and/or agent pain-points or suggestions for every case.

In some examples, product SAT information and/or feedback information may be provided to an engineering team for review. It may take an inordinate amount of time with varying degrees of accuracy for an engineering team to review large volumes of customer and/or agent feedback on one or more products in an attempt to understand product user needs/pain-points, determine similarities and differences, understand the big picture created my many product user comments, determine action items (e.g., remedies) and assign relative priorities to action items to resolve pain-points.

PDLC model(s) 304 provides a scalable method that improves efficiency and product satisfaction using intent classifier 330 and remedy prioritizer 332 to process and label product issues by importance. Product SAT information 326 and feedback information 328 (e.g., data collected through fishbone analysis and/or closed loop feedback) may be used by PDLC model(s) 304 to process and prioritize voluminous product SAT information 326 and feedback information 328 for product improvements. Product development scheduler 334 may schedule improvements in accordance with priorities determined by remedy prioritizer 332 to improve product satisfaction.

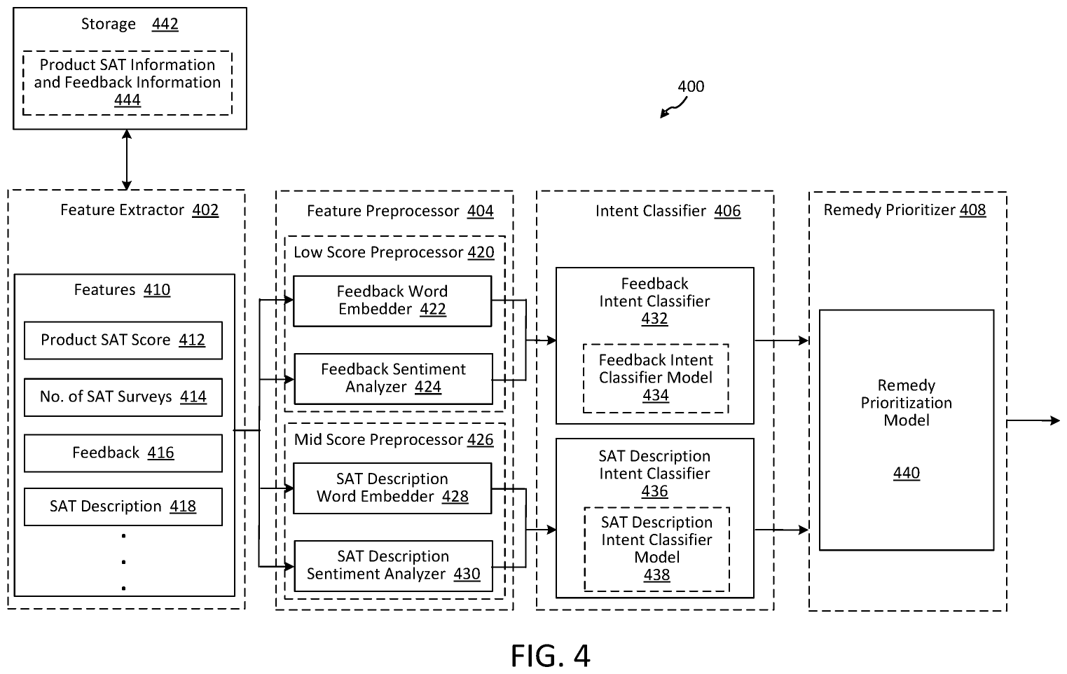

PDLC model(s) 304 may access and extract features from product SAT information 326 and feedback information 328. Feature preprocessing may be performed on extracted features. Intent classifier 330 may operate on preprocessed features. Intent classifier 330 and remedy prioritizer 332 may expedite, automate and improve the accuracy of determinations about intent and priority. Remedy prioritizer 332 may implement fuzzy logic rules for remedy prioritization. PDLC model(s) 304, is discussed in more detail by example in FIG. 4.

Product satisfaction monitor 302 may include satisfaction improvement tracker 324. Satisfaction improvement tracker 324 may monitor individual and average product satisfaction scores for one or more versions of one or more products. For example, satisfaction improvement tracker 324 may monitor (e.g., and generate reports) indicating relative (e.g., improved) satisfaction of customers and/or customer service agents (e.g., based on product SAT information 326) for an improved version and a previous version of one or more products.

FIG. 4 shows a block diagram of an example of a PDLC model, according to an example embodiment. Example PDLC model 400 may include feature extractor 402, feature preprocessor 404, intent classifier 406 and remedy prioritizer 408. PDLC model 400 is one of many possible example implementations. PDLC model 400 describes an example based on customer service agents and customer service agent products. Other examples may be implemented with respect to customers and customer products.

Feature extractor 402 may fetch customer and/or agent product SAT and feedback information (e.g., data) 444 from storage 442 for feature extraction. As previously indicated, feedback information may be gathered through closed loop feedback from customers and/or agents in response to low score SAT (e.g., survey) responses. Feedback may be stored in storage 442 (e.g., as SQL) and fetched from storage 442 for feature extraction. Product SAT information may be collected based on surveys filled out by customers and/or agents. Surveys may be part of a service request (SR). Attributes in the product SAT information (e.g., survey response data) may include, for example, one or more of the following: customer case ticket ID (e.g., case number) or SR Number; case title; customer issue title; case description; agent alias; agent SAT rating (e.g., SAT score); billing platform (e.g., legacy or modern); type of customer (e.g., partner led, field led, customer led); overall (e.g., total) customer SAT score (e.g., CSAT); total number of surveys filled out by an agent for a (e.g., SR) case ticket; type of customer product; type of product/tool used by agents to resolve customer issue tickets; agent's feedback; customer feedback; and/or the like.

In an example of customer and/or agent SAT data may fetched from storage 442, a total number of surveys submitted for a product (e.g., a customer service agent commerce support tool) may exceed 10,000 surveys. Table 1 describes an example distribution of 11,306 case tickets for customer support requests (SRs) by satisfaction (SAT) scores. The scores may relate to a variety of experiences with a variety of product features used for a variety of purposes.

TABLE 1

| Score | Number of case tickets (SRs) |
|---|---|
| 5 | 10406 |
| 4 | 550 |
| 3 | 155 |
| 2 | 51 |
| 1 | 44 |

In some examples, feedback may be collected (e.g., only) for cases with low (e.g., low range) SAT scores (e.g., specific feature score, general or overall SAT score, average score). Information in customer and/or agent feedback may be used as features for intent classification for cases (e.g., SRs) having low-range scores (e.g., scores 1 and 2). Information in product SAT (e.g., case) descriptions may be used as features for intent classification for cases (e.g., SRs) having mid-range and/or high-range scores (e.g., scores 3 and 4). Features that may contribute to ML and NLP based intent prediction may be product dependent (e.g., customer product, customer service agent product/tooling). Features that may contribute to ML and NLP based intent prediction may include, for example, one or more of the following: customer SAT score and/or agent SAT score; number of SAT score (e.g., survey) responses for an SR (e.g., case ticket); case description; agent feedback; sentiment score of agent feedback; and/or sentiment score of SAT report (e.g., case description).

Feature extractor 402 may extract a customer satisfaction (CSAT) score (e.g., product SAT score 412) as a feature for intent prediction (e.g., relative to customer products). Customers may indicate one or more issues (e.g., in one or more surveys) and rate or score their experience with one or more products. Customers may indicate issues and scores to agents (e.g., in unsolicited communications, in surveys and/or in feedback).

Feature extractor 402 may extract an agent satisfaction (SAT) score (e.g., product SAT score 412) as a feature for intent prediction. Customers may indicate one or more issues in support tickets for one or more SRs. Customer support agents may acknowledge and handle case tickets for SRs, for example, at a service desk using a case management tool. Agents may (e.g., at the time of ticket closure) be requested to fill out a survey to indicate their customer support product (e.g., tooling) experience while resolving customer issues in one or more case tickets for an SR. Agents may (e.g., be asked to) rate their tooling experience (e.g., between 1 to 5, where 5 is the highest score and 1 is the lowest score, although any scoring system may be used). In some examples, an agent's average rating of one or more tools may be referred to as an agent SAT score. An agent SAT score for a duration (e.g., weekly, monthly, yearly) may describe an overview of an agents' satisfaction with the agent's experience(s) with tooling (e.g., tooling experience satisfaction).

Feature extractor 402 may extract the number of related/associated SAT reports (e.g., survey responses for a case ticket) as a feature for intent prediction. A support ticket or a case may be reopened by a customer multiple times, for example, if an issue is not resolved. Customer support agents may submit a survey response each time a case is closed, which may be multiple times. A case/support ticket may have one or multiple survey responses. For example, a case may have eight (8) survey responses, each with a score of 1. An intent classification model support determination of the reasoning of low scores and the implementation of remedies (e.g., based on remedy prioritization model), which may improve customer service agent satisfaction with tooling experiences.

Feedback 416 (e.g., agent feedback) and SAT description 418 (e.g., case description) may be (e.g., vectorized) features for intent prediction. Closed loop feedback may include interaction with agents (e.g., automated or manual, such as by a product engineering team), for example, via a low score notification (e.g., email, text or audiovisual chat) to gather feedback to support an understanding of issues (e.g., pain-points).

Feature preprocessor 404 may preprocess text for intent prediction. Feature preprocessor may perform word vectorization for intent prediction using, for example, a word2vec Gensim model on agent feedback and/or case description. Feature preprocessor 404 may determine sentiment expressed by customers and/or agents in SAT descriptions and/or feedback for intent prediction.

Feature preprocessor 404 may include multiple preprocessors. Feature preprocessor 404 may be separated/divided based on SAT score, type of information, etc. For example, feature preprocessor 404 may include low score preprocessor 420 and mid score preprocessor 426.

Low score preprocessor 420 may operate on feedback information. Low score preprocessor 420 may include, for example, feedback word embedder 422 and feedback sentiment analyzer 424.

Mid score preprocessor 426 may operate on SAT description information. Mid score preprocessor 426 may include, for example, SAT description word embedder 428 and SAT description sentiment analyzer 430.

Feature preprocessor 404 may perform a sentiment analysis on extracted features, such as agent feedback and case description. Feature preprocessor 404 may generate sentiment scores for feedback and SAT description. Sentiment scores for (e.g., agent) feedback and SAT description (e.g., case description) may be features for intent prediction. Contextual information may be preserved, for example, by understanding sentiment. Sentiment may be used to predict the intent of agent feedback. A natural language toolkit (NLTK) sentiment analyzer library may be used to generate a sentiment score for each feedback. Feedback may be tagged as positive, for example, if a sentiment score is greater than 0.5. Feedback may be tagged as negative, for example, if a sentiment score is less than 0.5. Feedback may be tagged as neutral, for example, if a sentiment score is 0.5.

Feedback sentiment analyzer 424 may generate a sentiment score of agent feedback 416 as a feature for intent prediction. Understanding sentiment of feedback 416 may support understanding semantics of feedback 416 and predicting intent. SAT description sentiment analyzer 430 may generate a sentiment score of SAT description 418 as a feature for intent prediction. Understanding sentiment of SAT description 418 may support understanding semantics of SAT description 418 and predicting intent.

Feature preprocessor 404 may perform pre-processing on extracted features. Feedback word embedder 422 may perform word embedding on feedback 416 as a feature for intent prediction. SAT description word embedder 430 may perform word embedding on SAT description 418 as a feature for intent prediction.

Product attributes or features and/or product issues may be identified in (e.g., extracted from) SAT description 418 and/or feedback 416. Feature preprocessor 404 may operate on raw text in extracted features using NLP techniques, which may include, for example, one or more of the following: conversion to lowercase, removal of stop words, tokenization, stemming, and/or lemmatization. A dataset of stop words may be customized. One or more types of stop words (e.g., “should,” “must” or “can”) may not be removed, for example, if they might semantically refer to deontic expressions, such as “prohibition” or “permission.” Words may be selectively retained to prevent contextual information loss and/or to resolve semantic disambiguation.

Features extracted from feedback 416 and case description 418 may be raw text, which may include contextual ambiguity, for example, through grammatical errors. A word may have multiple contextual meanings or there may be various semantically similar words. Context disambiguation may be implemented (e.g., using Gensim Word2vec model) to generate word embedding model to vectorize agent feedback. The model may be a neural network architecture utilizing a continuous bag-of-words similar words. A skip-gram model may be built, trained and deployed. Several parameters may be determined, such as batch size, num skips and skip window. Skip windows may represent the number of words to be considered at left and right. Num skips may represent the number of output words selected in the span of a single word in (e.g., input, output) tuples. A training process may be unsupervised learning, for example, using Gensim. In some examples, training may be supervised. A set of words of interest may be used to evaluate similarity, for example, in steps (e.g., at selected step sizes). The model may be evaluated by looking at the most related (e.g., vectorized) words of the query words. For example, words such as “good” and “better” may be related.

Intent classifier 406 may classify the intent expressed in (e.g., extracted and preprocessed) features. Intent classifier 406 may include multiple intent classifiers. For example, intent classifier 406 may include feedback intent classifier 432 and SAT description intent classifier 436. Feedback intent classifier 432 may classify intent based on feedback intent classifier model 434. SAT description intent classifier 436 may classify intent based on SAT description intent classifier model 434. In some examples, intent classifier 406 may use one model while in other examples, intent classifier 406 may use two or more models.

Table 2 shows an example of intent classifications (e.g., performance, functionality, user interface, request, other) with example category IDs (e.g., 1, 2, 3, 4, 5).

TABLE 2

| Intent | Category ID |
|---|---|
| Performance | 1 |
| Functionality Issue | 2 |
| User Interface Issue | 3 |
| Functionality/Feature Request | 4 |
| Others | 5 |

Intent classifier 406 (e.g., feedback intent classifier 432) may analyze (e.g., classify based on) features extracted from agent feedback information 416 gathered from closed loop feedback for case tickets with low scores (e.g., scores 1 and 2). Intent classifier 406 (e.g., SAT description intent classifier 436) may analyze (e.g., classify based on) features extracted from SAT description information 418 for case tickets with mid-range to high-range scores (e.g., scores 3 and 4).

Ground truth for intent classifier 406 may be established based on a training set of data. For example, an initial training set may use a percentage (e.g., 70%) of SAT description (e.g., agent survey) data over a period of time (e.g., month(s), year(s)). A product engineering team may manually tag/label a training set of data with intents as category IDs (e.g., as shown by example in Table 3) for each feedback associated with a low score (e.g., scores 1 and 2) and for each SAT description (e.g., case description) associated with a mid-range to high-range score (e.g., scores 3 and 4). The training set of data may be labeled on a subrange of time (e.g., a weekly time period). A testing set of data may use a percentage (e.g., 30%) of SAT description (e.g., agent survey) data over a period of time (e.g., month(s), year(s)). The testing set of data may be used to evaluate the accuracy of the trained intent classifier model (e.g., feedback intent classifier model 434 and SAT description intent classifier model 438) in predicting intent. Predicted intent (e.g., intent classifications) by trained intent classifier 406 for test data may be evaluated for accuracy. Model training (e.g., with a training set) and validation (e.g., with a testing set) may be conducted periodically (e.g., once per month with input data).

Feedback intent classifier 432 may perform intent analysis for SAT reports (e.g., SAT surveys) having low scores (e.g., scores 1 and 2). As shown in FIG. 4, feedback intent classifier 432 may perform intent analysis on feedback 416, which may be gathered by product satisfaction monitor 302 using closed loop feedback for case tickets with low scores (e.g., scores 1 and 2). Feature extractor 402 may process agent feedback 416. Feature preprocessor 404 may perform word-embedding and calculate sentiment score for each feedback 416.

Model training may include performing K-fold cross validation using multiple classification machine learning algorithms to find a (e.g., best) fit model for training data. Table 3 shows an example of mean accuracy K Fold cross validation results of various classification models used in an example model training.

TABLE 3

| Classification Model | Mean Accuracy |
|---|---|
| Linear SVC | 0.795 |
| Logistic Regression | 0.8095 |
| Multinomial NB (Naive Bayes) | 0.786 |
| Random Forest Classifier | 0.7953 |
| XGB (Xtreme Gradient Boosting) | 0.8213 |

As shown in Table 3, in some examples, an Xtreme Gradient boosting an (XGB) classifier may perform better than at least some other algorithms (e.g., with 82% training accuracy). Intent classification model(s) (e.g., as shown in FIG. 4) may be trained on a training set. The trained intent classification model may predict intent on a test dataset.

Table 4 shows an example of overall accuracy (e.g., precision) and F1 score for each intent category predicted by intent classifier 406 for agent feedback provided for survey responses with low scores (e.g., scores 1 and 2). As shown by example in Table 4, in some examples, the overall accuracy for intent classification for agent feedback may be 89%.

TABLE 4

| Intent | Category | Precision | F1 Score |
|---|---|---|---|
| Performance 1 | 0.87 | 0.88 | |
| Functionality Issue | 2 | 0.86 | 0.865 |
| User Interface Issue | 3 | 0.82 | 0.81 |
| Feature Request | 4 | 0.84 | 0.85 |
| Others | 5 | 0.89 | 0.91 |

Intent classifier 406 (e.g., feedback intent classifier 432) may perform intent analysis (e.g., predict classifications) for SAT description 418 (e.g., survey responses) with mid-range to high-range scores (e.g., scores 3 and 4). Closed feedback loop (e.g., as shown in FIG. 3) may be implemented to focus on low score responses (e.g., scores 1 and 2). Closed loop feedback may find gaps or pain points and support resolution of issues with product (e.g., customer support agent tooling) experiences to improve an agent satisfaction score (agent SAT). Closed loop feedback may be referred to as a reactive model, where action is taken after receiving feedback from agents to prioritize product improvement(s) to increase satisfaction with product (e.g., tooling) experience.

In contrast, intent classifier 406 (e.g., SAT description intent classifier 436) may perform intent analysis (e.g., predict classifications) for survey responses with mid-range to high-range scores (e.g., scores 3 and 4) without agent feedback. Intent classification without feedback may be referred to as a proactive approach, where action may be taken to understand product issue areas through descriptions associated with SAT reports (e.g., case tickets) and (e.g., based on the classified intent) create repair work items and prioritize deliverables. Feature extractor 402 may extract SAT description 418 (e.g., case ticket description) as a feature for processing by feature preprocessor 404 and analysis by intent classifier 406. As shown in FIG. 4, SAT description word embedder 428 may run an embedding model (e.g., GensimWord embedding model) on SAT descriptions (e.g., case descriptions) to generate vectorized case-descriptions. SAT description sentiment analyzer 430 may perform sentiment analysis on case descriptions to generate a predicted understanding of customers' sentiment towards one or more product issues. In some examples, a feature set for intent analysis on survey responses with mid-range to high-range scores (e.g., scores 3 and 4) may include, for example, one or more of the following: product SAT score 412 (e.g., agent SAT score); number of SAT surveys per case ticket 414; vectorized SAT description (e.g., case description) 418; and/or sentiment score of SAT description (e.g., case description) generated by SAT description sentiment analyzer 430.

Ground truth may be determined, for example, by manually reviewing each SAT description 418 (e.g., case description) in a model training set and tagging/labeling intents as category IDs (e.g., as shown by example in Table 2) for each of the case descriptions in the training set. The training set may be a percentage (e.g., 70%) of case descriptions in a given period (e.g., each weekly period) within a larger time period (e.g., months or years) for a training set of case description raw input.

K fold cross validation may be performed using multiple classification machine learning (ML) algorithms to determine a (e.g., best fit) model for intent classifier 406 (e.g., SAT description intent classifier model 438) based on training data. Table 5 shows an example of mean accuracy K Fold cross validation results of various classification models.

TABLE 5

| Classification Model | Mean Accuracy |
|---|---|
| Linear SVC | 0.831 |
| Logistic Regression | 0.791 |
| Multinomial NB (Naive Bayes) | 0.795 |
| Random Forest Classifier | 0.812 |
| XGB (Xtreme Gradient Boosting) | 0.851 |

As shown in Table 5, in some examples, an XGB classifier may perform better than at least some other models (e.g., with 85.1% training accuracy). The selected intent classification model(s) may be trained on a training set.

Trained intent classification model(s) may predict intent on a test dataset. Table 6 shows an example of overall accuracy (e.g., precision) and F1 score for each intent category predicted by intent classifier 406 (e.g., SAT description intent classifier 436) for SAT description (e.g., case description) features from SAT survey responses with mid-range to high-range scores (e.g., scores 3 and 4). As shown by example in Table 6, in some examples, the overall accuracy for intent classification for agent feedback may be 88%.

TABLE 6

| Intent | Category | Precision | F1 Score |
|---|---|---|---|
| Performance | 1 | 0.85 | 0.86 |
| Functionality Issue | 2 | 0.83.4 | 0.85 |
| User Interface Issue | 3 | 0.81 | 0.81 |
| Feature Request | 4 | 0.89 | 0.89 |
| Others | 5 | 0.88 | 0.89 |

Large volumes of case tickets may be generated by customer service agents every week. Low scores may lead to significant feedback from agents, which may be sought by and provided to a product (e.g., tool) engineering team through a CFL. Automation of intent classification and remedy selection and prioritization may permit engineering teams to focus on improvements and avoid sifting through large quantities of information to comprehend intent in case descriptions and/or feedback, understand potential product issues (e.g., pain-points), and determine and schedule implementation of repair items to improve customer and/or agent satisfaction.

Remedy prioritizer 408 may determine priorities based on remedy prioritization model 440. Remedy prioritization model 440 may be a fuzzy logic based remedy prioritization model. Remedy prioritization model 440 may be trained with training data based on a data split (e.g., 80/20% split) for training and testing.

Remedy prioritizer 408 may operate (e.g., at least in part) on the outputs generated by intent classifier 406. Remedy prioritizer 408 may prioritize issues described by feedback 416 and/or SAT descriptions 418 for remedies (e.g., at least in part) based on the input received from intent classifier 406. Remedy prioritizer 408 may implement supervised (e.g., or unsupervised) fuzzy logic based rules for remedy prioritization.

Remedy prioritizer 408 may, for each repair item (e.g., action item) associated with agent feedback for low scores (e.g., scores 1 and 2) and case description for mid- to high-range scores (e.g., scores 3 and 4), automatically predict the priority of action items and/or a time of resolution or deadline for action items. In some examples, remedy prioritizer 408 may use one or more of the following attributes to determine the priority of work items: predicted intent, SAT score (e.g., agent score), number of surveys submitted for a case ticket (e.g., service request (SR)), and/or sentiment of feedback or case description.

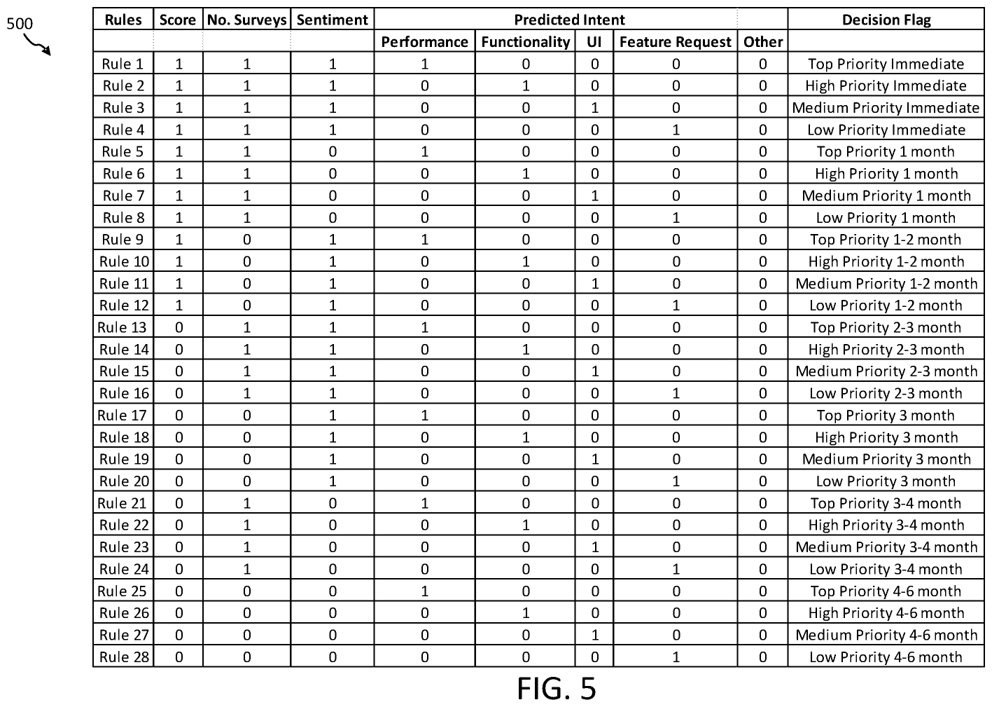

For example, intent classifier 406 may predict intent for an SAT description (e.g., case ticket description) to be a performance issue. Low scores may have been given by an agent for experience with the tool. Remedy prioritizer 408 may prioritize the work item created to fix the performance issue as, for example, “Top Most Priority” (e.g., as shown by example logic in FIG. 5). In another example, intent classifier 406 may predict intent for an SAT description (e.g., case ticket description) to be a functionality issue. Remedy prioritizer 408 may prioritize the work item created to fix the functionality issue as, for example, “High Priority” (e.g., as shown by example logic in FIG. 5). A deadline for implementation may depend upon one or more (e.g., other) parameters, such as the number of (e.g., low score) SAT surveys 414 (e.g., submitted by the agent for a case), sentiment of feedback 416, SAT score 412, etc. A priority of a work item may be high, for example, if the number of surveys with negative sentiment per case ticket is high.

Remedy prioritizer 408 may implement fuzzy prioritization rules, for example, based on empirical prior work prioritization experience by an engineering team. Fuzzy rules may be based on attributes and corresponding decision flags.

Table 7 shows an example of a score attribute, which may represent an agent SAT score (e.g., ranging from 1 to 5). Agent's may provide SAT scores as part of a survey response at the time of customer service ticket closure.

TABLE 7

| Score | Decision Flag |
|---|---|
| Score ≤ 2 | 1 (Yes) or 0 (No) |

Table 8 shows an example of a number of survey responses attribute, which may represent the total number of surveys submitted by one or more agents for an individual customer service case ticket.

TABLE 8

| No. of Survey Responses | Decision Flag |
|---|---|
| No. of Survey Responses ≤ 2 | 0 (Yes) or 1 (No) |

Table 9 shows an example of a sentiment attribute, which may represent the sentiment score calculated for agent feedback (e.g., for low scores 1 and 2) or case description (e.g., for mid- to high-range scores 3 and 4) for individual case tickets. Boolean values shown may be assigned to represent real (e.g., normalized) values between zero (0) and one (1). Boolean values zero (0) and one (1) may represent “low” and “high” values.

TABLE 9

| Sentiment | Decision Flag |
|---|---|
| Negative | 1 |
| Positive or Neutral | 0 |

Table 10 shows an example of an intent attribute, which may represent a an intent predicted by intent classifier 406 for agent feedback (e.g., for low scores 1 and 2) or case description (e.g., for mid- to high-range scores 3 and 4) for individual case tickets.

TABLE 10

| Intent | Decision Flag |
|---|---|
| Performance Issue | 1 (Yes) or 0 (No) |
| Functionality Issue | 1 (Yes) or 0 (No) |
| User Interface Issue | 1 (Yes) or 0 (No) |
| Feature Request | 1 (Yes) or 0 (No) |
| Others | 1 (Yes) or 0 (No) |

Remedy prioritizer 408 may determine a priority of a work item based on fuzzy rules weighted towards a predicted intent attribute. One or more other rules may be carried out according to determinations based on the determined priority of work items. In an example, a case with intent classified as “performance” may be prioritized as “Top-Most” priority. Reasoning for a fuzzy logic rule may be that slow performance of a tool or feature leads to latency in resolving customer issues, thereby leading to low agent SAT score and/or CSAT Sore. Remedy prioritizer 408 may determine priority based on predicted intent according to agent pain-points and agent preferences.

Remedy prioritizer 408 may determine prioritization in terms of remedy completion timeframe or deadline based on one or more (e.g., any combination) of the following: SAT score 412, number of surveys 414 and sentiment score of feedback generated by feature preprocessor 404.

FIG. 5 shows a table of example of fuzzy logic rules 500 that may be applied by a remedy prioritizer (e.g., remedy prioritizer 408). Fuzzy logic rules 500 may be supervised (e.g., or unsupervised) learning based fuzzy logic rules.

In the example rules shown in FIG. 5, remedy prioritization rules 1-4 may be for case tickets with low scores (e.g., scores 1 and 2), multiple (e.g., two or more) surveys, and negative sentiments.

Remedy prioritization rules 5-8 may be for case tickets with low scores (e.g., scores 1 and 2), multiple (e.g., two or more) surveys, and neutral or positive sentiments.

Remedy prioritization rules 9-12 may be for case tickets with low scores (e.g., scores 1 and 2), one or two surveys, and negative sentiments.

Remedy prioritization rules 13-16 may be for case tickets with scores being 2 or higher, multiple (e.g., two or more) surveys, and negative sentiments.

Remedy prioritization rules 17-20 may be for case tickets with scores being 2 or higher, one or two surveys, and negative sentiments.

Remedy prioritization rules 21-24 may be for case tickets with scores being 2 or higher, multiple (e.g., two or more) surveys, and neutral or positive sentiments.

Remedy prioritization rules 25-28 may be for case tickets with scores being 2 or higher, one or two surveys, and neutral or positive sentiments.

Remedy prioritization may pre-sort potential product issues for product and/or service teams (e.g., product team(s) 107) to address for mitigation strategies to improve customer and/or agent satisfaction.

In some examples (e.g., as shown in FIG. 5), a priority of work items may be based on intent predicted for case tickets. In some examples, time of resolution for work items with the same assigned priority may be based on agent score, number of surveys submitted and/or sentiment analysis of agent feedback or case description. For example, as shown in fuzzy logic rules 1-4 in FIG. 5, a case ticket with a score of 1 or 2, two or more surveys (e.g., for a low score case ticket) with negative sentiment may be prioritized as immediate. In some examples (e.g., as shown in FIG. 5), there may be four classes of immediate (e.g., low, moderate, high, top).

For example, as shown in fuzzy logic rules 5-8 in FIG. 5, a case ticket expressing a neutral or positive sentiment may be prioritized for solution in one (1) month. Case tickets with scores greater than two (2) may be prioritized for solution of customer and/or agent pain points in 2-3 months. e.g., before escalation to a major issue in upcoming months.

For example, as shown in fuzzy logic rules 24-28 in FIG. 5, case tickets with scores greater than or equal to 2 and neutral or positive customer sentiment may be prioritized for solution of customer and/or agent pain points (if any) in 4-6 months.

Voluminous (e.g., overwhelming) customer and/or customer service agent service requests, case reports, survey responses, feedback, etc. may be prioritized by a machine learning model for one or more product and/or service teams to more quickly and accurately improve customer and/or agent satisfaction with products, services, tools, etc. An ML model may prioritize customer and/or customer service agent service requests, case reports, feedback, etc. for product and/or service teams based on classifications of expressed issues. Customer and/or customer service agent service requests, case reports, feedback, etc. may be sorted and handled differently.

Product service request information may be selectively processed based on satisfaction scores provided by customers and/or agents to determine a product issue category (classify intent expressed by customer and/or agent) based on scores (e.g., a range of scores), and assigning handling priority for engineering team(s) based on the intent classifications. Improving customer service products to improve customer service agent satisfaction may also improve customer satisfaction, e.g., by improving the capability and speed of resolution of issues for customers.

In some examples, a multi-step (e.g., a three-step) approach may be used to improve customer and/or customer agent satisfaction, for example, by gathering feedback, predicting the overall intent of the feedback as a reactive approach and intent of case descriptions as a proactive approach, and performing (e.g., fuzzy logic based) remedy prioritization. Closed loop feedback in a satisfaction monitor may automatically trigger low score notification (e.g., feedback request) to customers and/or agents who gave low scores for a customer and/or customer agent product, such as a billing and subscription program (e.g., commerce support tool (CST) or commerce management agent tool (CMAT)). Feedback may be translated into case reviews. An intent classification model may understand and summarize the overall intent or pain-point of a customer and/or an agent. An intent classification model may be trained by data collected from closed loop feedback (e.g., for low scores). Data may be split (e.g., 70/30% split) for training and testing the intent classification model. In an example, overall accuracy for intent classification may be, for example, 89% for survey responses with low scores (e.g., scores 1 and 2) and 87.5% for survey responses with mid-range to high-range scores (e.g., scores 3 and 4).

Agent Satisfaction (Agent SAT) and Customer Satisfaction (CSAT) scores may be mapped and fetched from storage. A blended framework comprising closed loop feedback, (e.g., supervised or unsupervised) intent prediction and remedy prioritization may improve customer and/or agent SAT scores (e.g., for a customer billing and subscription program). Work items or repair items for commerce support tool (CST) and commerce management agent tool (CMAT) may be identified and delivered with priorities and completion dates to one or more engineering teams. For example, a work item improvement may be to enable support agent to solve a customer issue immediately without delay by escalation to an engineering team, avoiding days to resolve customer reported issues (CRIs). Prioritizing some work items for customer product and/or agent support tools over voluminous other work items may quickly improve customer and agent SAT scores.

A blended framework to improve customer and/or customer service agent satisfaction may include cause and effect analysis and/or closed loop feedback to gather voluminous indications of potential product issues, a feature extractor to extract features from the indications, a feature preprocessor to preprocess features for sentiment expressed in the indications, an intent classification model to classify product issues expressed in the indications, and a remedy prioritization model (e.g., using fuzzy logic riles) to prioritize (e.g., sort and queue) work items to provide remedies that improve satisfaction with products used by customers and/or agents.

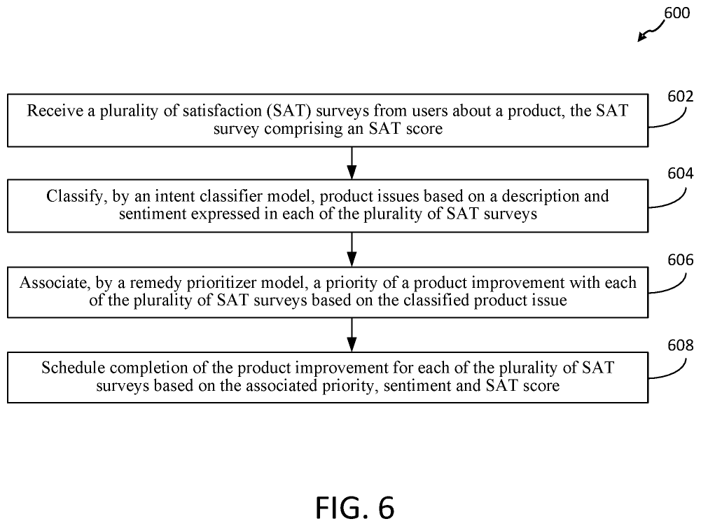

FIG. 6 shows a flowchart of an example method for prioritizing and scheduling completion of product remedies based on an intent classifier model and a remedy prioritizer model, according to an example embodiment. Embodiments disclosed herein and other embodiments may operate in accordance with example method 600. Method 600 comprises steps 602-608. However, other embodiments may operate according to other methods. Other structural and operational embodiments will be apparent to persons skilled in the relevant art(s) based on the foregoing discussion of embodiments. No order of steps is required unless expressly indicated or inherently required. There is no requirement that a method embodiment implement all of the steps illustrated in FIG. 6. FIG. 6 is simply one of many possible embodiments. Embodiments may implement fewer, more or different steps.

As shown in FIG. 6, in step 602, a plurality of satisfaction (SAT) surveys may be received from users about a product. A (e.g., each) SAT survey may comprise an SAT score. For example, as shown in FIGS. 1, 3 and 4, product SAT reports 112 with product SAT information 326, including SAT descriptions 418 and product SAT scores 412 may be provided by customers and/or agents to product satisfaction monitor 128, 302.

As shown in FIG. 6, in step 604, product issues may be classified (e.g., by an intent classifier model) based on a description and sentiment expressed in each of the plurality of SAT surveys. For example, as shown in FIGS. 3 and 4, intent classifier 330, 406 may classify product issues (e.g., as shown by example in Table 2) based on SAT description 418 and/or feedback 416 and sentiment generated by SAT description or feedback sentiment analyzer 430, 424.

As shown in FIG. 6, in step 606, a priority of a product improvement may be associated (e.g., by a remedy prioritizer model) with each of the plurality of SAT surveys based on the classified product issue. For example, as shown in FIGS. 3 and 4, remedy prioritizer 332, 408 may associate a priority (e.g., based on fuzzy logic shown in FIG. 5) with each product SAT information 326/SAT description 418 based (e.g., at least in part) on intent (e.g., product issue) classifications provided by intent classifier 330, 406.

As shown in FIG. 6, in step 608, completion of the product improvement may be scheduled for each of the plurality of SAT surveys based on the associated priority, sentiment and SAT score. For example, as shown in FIGS. 1 and 3, product development scheduler 124, 334 may schedule product improvements to be completed for each SAT information 326/SAT description 418 based on associated priority, sentiment and SAT score utilized by example fuzzy logic shown in FIG. 5 used by remedy prioritizer 332, 408.

### III. Example Computing Device Embodiments

As noted herein, the embodiments described, along with any modules, components and/or subcomponents thereof, as well as the flowcharts/flow diagrams described herein, including portions thereof, and/or other embodiments, may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC), a field programmable gate army (FPGA), and/or an application specific integrated circuit (ASIC). A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

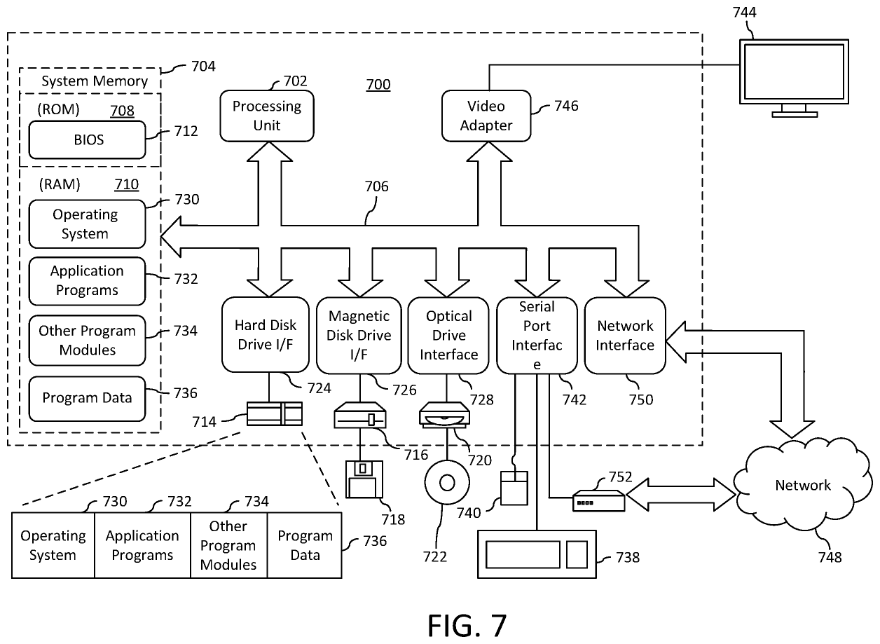

FIG. 7 shows an exemplary implementation of a computing device 700 in which example embodiments may be implemented. Consistent with all other descriptions provided herein, the description of computing device 700 is a non-limiting example for purposes of illustration. Example embodiments may be implemented in other types of computer systems, as would be known to persons skilled in the relevant art(s).

As shown in FIG. 7, computing device 700 includes one or more processors, referred to as processor circuit 702, a system memory 704, and a bus 706 that couples various system components including system memory 704 to processor circuit 702. Processor circuit 702 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 702 may execute program code stored in a computer readable medium, such as program code of operating system 730, application programs 732, other programs 734, etc. Bus 706 represents one or more of any of several types of bus structures, including a memory bus or memory controller, a peripheral bus, an accelerated graphics port, and a processor or local bus using any of a variety of bus architectures. System memory 704 includes read only memory (ROM) 708 and random-access memory (RAM) 710. A basic input % output system 712 (BIOS) is stored in ROM 708.

Computing device 700 also has one or more of the following drives: a hard disk drive 714 for reading from and writing to a hard disk, a magnetic disk drive 716 for reading from or writing to a removable magnetic disk 718, and an optical disk drive 720 for reading from or writing to a removable optical disk 722 such as a CD ROM, DVD ROM, or other optical media. Hard disk drive 714, magnetic disk drive 716, and optical disk drive 720 are connected to bus 706 by a hard disk drive interface 724, a magnetic disk drive interface 726, and an optical drive interface 728, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk. ROM, or RAM. These programs include operating system 730, one or more application programs 732, other programs 734, and program data 736. Application programs 732 or other programs 734 may include, for example, computer program logic (e.g., computer program code or instructions) for implementing example embodiments described herein.

A user may enter commands and information into the computing device 700 through input devices such as keyboard 738 and pointing device 740. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 702 through a serial port interface 742 that is coupled to bus 706, but may be connected by other interfaces, such as a parallel port, game port, or a universal serial bus (USB).

A display screen 744 is also connected to bus 706 via an interface, such as a video adapter 746. Display screen 744 may be external to, or incorporated in computing device 700. Display screen 744 may display information, as well as being a user interface for receiving user commands and/or other information (e.g., by touch, finger gestures, virtual keyboard, etc.). In addition to display screen 744, computing device 700 may include other peripheral output devices (not shown) such as speakers and printers.

Computing device 700 is connected to a network 748 (e.g., the Internet) through an adaptor or network interface 750, a modem 752, or other means for establishing communications over the network. Modem 752, which may be internal or external, may be connected to bus 706 via serial port interface 742, as shown in FIG. 7, or may be connected to bus 706 using another interface type, including a parallel interface.

As used herein, the terms “computer program medium,” “computer-readable medium,” and “computer-readable storage medium” are used to refer to physical hardware media such as the hard disk associated with hard disk drive 714, removable magnetic disk 718, removable optical disk 722, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media that are separate and non-overlapping with embodiments directed to computer-readable storage media.

As noted above, computer programs and modules (including application programs 732 and other programs 734) may be stored on the hard disk, magnetic disk, optical disk, ROM, RAM, or other hardware storage medium. Such computer programs may also be received via network interface 750, serial port interface 742, or any other interface type. Such computer programs, when executed or loaded by an application, enable computing device 700 to implement features of example embodiments described herein. Accordingly, such computer programs represent controllers of the computing device 700.

Example embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. Example Embodiments

Methods, systems and computer program products are provided for machine learning product and product support development. A machine learning product development life cycle model improves customer and support agent satisfaction by prioritizing improvements in customer or support products based on classification of interpretations of customer and/or support agent input. A product satisfaction monitor receives user satisfaction (SAT) reports with SAT scores. Feedback is requested for low SAT scores. A feature extractor/preprocessor prepares model descriptions and sentiment from SAT reports based on case descriptions for mid- to high-range SAT scores and from feedback for low-range SAT scores. An intent classifier model classifies product issues based on description and sentiment. A remedy prioritizer model associates a priority of product improvement with each SAT report (or related group of reports) based on the classified product issue, sentiment, SAT score and/or number of SAT reports (e.g., for a single SR). A product improvement scheduler schedules each SAT report for remediation in an improved product based on each associated priority.

In examples, a system may comprise one or more processors and one or more memory devices that store program code configured to be executed by the one or more processors. The program code may comprise a product (e.g., software) development lifecycle (PDLC) model. A product may comprise a product for a customer, a customer support product for a customer service agent, etc. The PDLC model may comprise, for example, a product satisfaction monitor configured to receive a plurality of satisfaction (SAT) surveys (e.g., reports or indications) from users about a product A SAT survey may include information provided in a variety of forms, such as, for example, one or more of the following: user comments, service request (SRs), case tickets, surveys associated with case tickets for SRs, requested feedback, and so on. The PDLC model may comprise, for example, an intent classifier configured with an intent classifier model that classifies product issues based on a description and sentiment expressed in each of the plurality of SAT surveys. The PDLC model may comprise, for example, a remedy prioritizer configured with a fuzzy logic remedy prioritizer model (e.g., using a plurality of fuzzy logic rules) that associates a priority of a product improvement with each of the plurality of SAT surveys based on the classified product issue. The PDLC model may comprise, for example, a product improvement scheduler configured to schedule each of the plurality of SAT surveys for remediation based on each associated priority of product improvement for ordered implementation in an improved product.

In examples, the product may comprise customer service support software executable by one or more computing devices and the user comprises a customer service support agent. In other examples, the product may comprise software or a software platform executable by one or more computing devices and the user may comprise a customer.

In examples, the PDLC model may (e.g., further) comprise a satisfaction improvement tracker configured to periodically track improvement in user satisfaction with the improved product. The PDLC model may (e.g., further) comprise a trainer configured to retrain at least one of the intent classifier model or the remedy prioritizer model periodically or based on the tracked improvement in user satisfaction.

In examples, an SAT survey may be associated with an SAT score. The PDLC model may (e.g., further) comprise a low score trigger configured to request user feedback for an SAT survey if the associated SAT score is below a low score threshold.

In examples, the PDLC model may (e.g., further) comprise a feature extractor configured to extract a set of features from information in each of the plurality of SAT surveys; and a feature preprocessor configured to process each set of features to generate the description and sentiment for each of the plurality of SAT surveys.

In examples, the feature preprocessor may comprise a first feature preprocessor configured to generate the description and sentiment from information in each SAT survey associated with a mid-range to high-range SAT score; and a second feature preprocessor configured to generate the description and sentiment from information in the user feedback for each SAT survey associated with a low SAT score.

In examples, the remedy prioritizer model may associate a priority of a product improvement with each of the plurality of SAT surveys based on the classified product issue, the sentiment, and an SAT score.

In examples, a computer-implemented method of improving a product (e.g., a customer support tool or customer product) for users (e.g., a customer support agent or customer) may comprise receiving a plurality of satisfaction (SAT) surveys from users about a product, the SAT survey comprising an SAT score (e.g., in comments, service request (SRs), case tickets, surveys associated with case tickets for SRs, requested feedback, and/or other communications). The method may classify, by an intent classifier model, product issues based on a description and sentiment expressed in each of the plurality of SAT surveys. The method may associate, by a remedy prioritizer model, a priority of a product improvement with each of the plurality of SAT surveys based on the classified product issue. The method may schedule completion of the product improvement for each of the plurality of SAT surveys based on the associated priority, sentiment and SAT score.

In examples, the product may comprise customer service support software executable by one or more computing devices and the user may comprise a customer service support agent.

In examples, the method may (e.g., further) comprise tracking improvement in user satisfaction with the improved product; and retraining at least one of the intent classifier model or the remedy prioritizer model periodically or based on the tracked improvement in user satisfaction.

In examples, the method may (e.g., further) comprise requesting user feedback for an SAT survey if the associated SAT score is below a low score threshold.

In examples, the method may (e.g., further) comprise extracting a set of features from information in each of the plurality of SAT surveys; and processing each set of features to generate the description and sentiment for each of the plurality of SAT surveys.

In examples, processing each set of features may comprise generating the description and sentiment from information in each SAT survey associated with a mid-range to high-range SAT score; and generating the description and sentiment from information in the user feedback for each SAT survey associated with a low SAT score.

In examples, at least one SAT survey in the plurality of SAT surveys may represent a plurality of associated, merged or combined SAT surveys. In examples, the method may (e.g., further) comprise scheduling completion of the product improvement for each of the plurality of SAT surveys based on the associated priority, sentiment, SAT score, and the number of associated, merged or combined SAT surveys represented.

In examples, a computer-readable storage medium may have program instructions recorded thereon that, when executed by a processing circuit, perform a method comprising: receiving a plurality of satisfaction (SAT) surveys from users about a product, the SAT survey comprising an SAT score; requesting user feedback for an SAT survey if the associated SAT score is below a low score threshold; classifying, by an intent classifier model, product issues based on a description and sentiment expressed in each of the plurality of SAT surveys; associating, by a remedy prioritizer model, a priority of a product improvement with each of the plurality of SAT surveys based on the classified product issue; and scheduling completion of the product improvement for each of the plurality of SAT surveys based on the associated priority, sentiment and SAT score.

In examples, the product may comprise customer service support software executable by one or more computing devices and the user comprises a customer service support agent.

In examples, the method may (e.g., further) comprise tracking improvement in user satisfaction with the improved product; and retraining at least one of the intent classifier model or the remedy prioritizer model periodically or based on the tracked improvement in user satisfaction.

In examples, the method may (e.g., further) comprise extracting a set of features from information in each of the plurality of SAT surveys, and processing each set of features to generate the description and sentiment for each of the plurality of SAT surveys.

In examples, processing each set of features may comprise generating the description and sentiment from information in each SAT survey associated with a mid-range to high-range SAT score; and generating the description and sentiment from information in the user feedback for each SAT survey associated with a low SAT score.

In examples, at least one SAT survey in the plurality of SAT surveys may represent a plurality of associated, merged or combined SAT surveys. In examples, the method may (e.g., further) comprise, scheduling completion of the product improvement for each of the plurality of SAT surveys based on the associated priority, sentiment, SAT score, and the number of associated, merged or combined SAT surveys represented.

### V. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A system, comprising:
one or more processors; and
one or more memory devices that store program code configured to be executed by the one or more processors, the program code comprising a product development lifecycle (PDLC) model comprising:
a product satisfaction monitor configured to receive a plurality of satisfaction (SAT) surveys from users about a product;
an intent classifier configured with an intent classifier model that classifies product issues based on a description and sentiment expressed in each of the plurality of SAT surveys;
a remedy prioritizer configured with a fuzzy logic remedy prioritizer model that associates a priority of a product improvement with each of the plurality of SAT surveys based on the classified product issue; and
a product improvement scheduler configured to schedule each of the plurality of SAT surveys for remediation based on each associated priority of product improvement for ordered implementation in an improved product.

2. The system of claim 1, wherein the product comprises customer service support software executable by one or more computing devices and the user comprises a customer service support agent.

3. The system of claim 1, the PDLC model further comprising:
a satisfaction improvement tracker configured to periodically track improvement in user satisfaction with the improved product; and
a trainer configured to retrain at least one of the intent classifier model or the remedy prioritizer model periodically or based on the tracked improvement in user satisfaction.

4. The system of claim 1, wherein an SAT survey is associated with an SAT score, the PDLC model further comprising:
a low score trigger configured to request user feedback for an SAT survey if the associated SAT score is below a low score threshold.

5. The system of claim 4, the PDLC model further comprising:
a feature extractor configured to extract a set of features from information in each of the plurality of SAT surveys; and
a feature preprocessor configured to process each set of features to generate the description and sentiment for each of the plurality of SAT surveys.

6. The system of claim 5, wherein the feature preprocessor comprises:
a first feature preprocessor configured to generate the description and sentiment from information in each SAT survey associated with a mid-range to high-range SAT score; and
a second feature preprocessor configured to generate the description and sentiment from information in the user feedback for each SAT survey associated with a low SAT score.

7. The system of claim 1, wherein the remedy prioritizer model associates a priority of a product improvement with each of the plurality of SAT surveys based on the classified product issue, the sentiment, and an SAT score.

8. A computer-implemented method of improving a product for users comprising:
receiving a plurality of satisfaction (SAT) surveys from users about a product, the SAT survey comprising an SAT score;
classifying, by an intent classifier model, product issues based on a description and sentiment expressed in each of the plurality of SAT surveys;
associating, by a remedy prioritizer model, a priority of a product improvement with each of the plurality of SAT surveys based on the classified product issue; and
scheduling completion of the product improvement for each of the plurality of SAT surveys based on the associated priority, sentiment and SAT score.

9. The computer-implemented method of claim 8, wherein the product comprises customer service support software executable by one or more computing devices and the user comprises a customer service support agent.

10. The computer-implemented method of claim 8, further comprising:
tracking improvement in user satisfaction with the improved product; and
retraining at least one of the intent classifier model or the remedy prioritizer model periodically or based on the tracked improvement in user satisfaction.

11. The computer-implemented method of claim 8, further comprising:
requesting user feedback for an SAT survey if the associated SAT score is below a low score threshold.

12. The computer-implemented method of claim 11, further comprising:
extracting a set of features from information in each of the plurality of SAT surveys; and
processing each set of features to generate the description and sentiment for each of the plurality of SAT surveys.

13. The computer-implemented method of claim 12, wherein processing each set of features comprises:
generating the description and sentiment from information in each SAT survey associated with a mid-range to high-range SAT score; and
generating the description and sentiment from information in the user feedback for each SAT survey associated with a low SAT score.

14. The computer-implemented method of claim 8, further comprising:
wherein at least one SAT survey in the plurality of SAT surveys represents a plurality of associated, merged or combined SAT surveys; and
scheduling completion of the product improvement for each of the plurality of SAT surveys based on the associated priority, sentiment, SAT score, and the number of associated, merged or combined SAT surveys represented.

15. A computer-readable storage medium having program instructions recorded thereon that, when executed by a processing circuit, perform a method comprising:
receiving a plurality of satisfaction (SAT) surveys from users about a product, the SAT survey comprising an SAT score;
requesting user feedback for an SAT survey if the associated SAT score is below a low score threshold;
classifying, by an intent classifier model, product issues based on a description and sentiment expressed in each of the plurality of SAT surveys;
associating, by a remedy prioritizer model, a priority of a product improvement with each of the plurality of SAT surveys based on the classified product issue; and
scheduling completion of the product improvement for each of the plurality of SAT surveys based on the associated priority, sentiment and SAT score.

16. The computer-readable storage medium of claim 15, wherein the product comprises customer service support software executable by one or more computing devices and the user comprises a customer service support agent.

17. The computer-readable storage medium of claim 15, the method further comprising:
tracking improvement in user satisfaction with the improved product; and
retraining at least one of the intent classifier model or the remedy prioritizer model periodically or based on the tracked improvement in user satisfaction.

18. The computer-readable storage medium of claim 15, the method further comprising:
extracting a set of features from information in each of the plurality of SAT surveys; and
processing each set of features to generate the description and sentiment for each of the plurality of SAT surveys.

19. The computer-readable storage medium of claim 18, wherein processing each set of features comprises:
generating the description and sentiment from information in each SAT survey associated with a mid-range to high-range SAT score; and
generating the description and sentiment from information in the user feedback for each SAT survey associated with a low SAT score.

20. The computer-readable storage medium of claim 15, the method further comprising:
wherein at least one SAT survey in the plurality of SAT surveys represents a plurality of associated, merged or combined SAT surveys; and
scheduling completion of the product improvement for each of the plurality of SAT surveys based on the associated priority, sentiment, SAT score, and the number of associated, merged or combined SAT surveys represented.
